(19) United States
(12) Patent Application Publication
(10) Pub. No.: US 2003/0033143 A1
(43) Pub. Date: Feb. 13, 2003

(54) Decreasing noise sensitivity in speech processing under adverse conditions

(76) Inventor: Hagai Aronowitz, Peta-Tikva (IL)

Correspondence Address: Timothy N. Trop, TROP, PRUNER & HU, P.C., 8554 KATY FWY, STE 100, HOUSTON, TX, 77024-1805, US

(21) Appl. No.: 09/928,766

(22) Filed: Aug. 13, 2001

(51) Int. Cl. G10L 15/20

(52) U.S. Cl. 704/233

(57) ABSTRACT

To perform reliable speech or speaker recognition (e.g., verification or identification) in adverse conditions, such as noisy environments, a noise compensation mechanism increases noise robustness while speech processing by decreasing noise sensitivity. Signal attributes and noise attributes of at least two signal portions including speech may be determined. Using the signal attributes of both signal portions, a distance measure for one signal portion by using the signal attributes of both signal portions may be derived. In one embodiment, using a Parallel Model Combination (PMC) algorithm, a normalized absolute distance score may be obtained for a noisy speech signal including an utterance. For accurate rejection or acceptance of speech or speaker (registered speakers or imposters), the normalized absolute distance score may be compared to a dynamic threshold or one or more speech or speaker profiles.

### BACKGROUND

The present invention relates generally to speech processing systems, and more particularly to speech or speaker recognition systems operating under adverse conditions, such as in noisy environments.

Speech or speaker recognition pertains mostly to automatically recognizing a speaker based on the individual audio information included in an utterance (e.g., a speech, voice, or acoustic signal). Example applications of the speaker recognition include allowing convenient use of the speaker's voice for authentication while providing voice-activated dialing, secured banking or shopping via a processor-based device, database access or information services, authenticated voice mail, security control for confidential information areas, and controlled remote access to a variety of electronic systems such as computers.

In general, the speaker recognition is classified into two broad categories namely, speech or speaker identification and speech or speaker verification. Speech or speaker identification entails determining which registered speaker may have been an author of a particular utterance. On the other hand, speech or speaker verification involves accepting or rejecting the identity claim of a speaker based on the analysis of the particular utterance. In any case, when appropriately deployed, a speaker recognition system converts an utterance, captured by a microphone (e.g., integrated with a portable device such as a wired or mobile phone), into a set of audio indications determined from the utterance. The set of audio indications serves as an input to a speech processor in order to achieve an acceptable understanding of the utterance.

However, accurate speech processing of the utterance in a conventional speech or speaker recognition system is recognized as a difficult problem, largely because of the many sources of variability associated with the environment of the utterance. For example, a typical speech or speaker recognition system that may perform acceptably in controlled environments, but when used in adverse conditions (e.g., in noisy environments), the performance may deteriorate rather rapidly. This usually happens because noise may contribute to inaccurate speech processing thus compromising reliable identification of the speaker, or alternatively, rejection of imposters in many situations. Thus, while processing speech, a certain level of noise robustness in speech or speaker recognition system may be desirable.

Generally, noise robustness in speech or speaker recognition system refers to the need to maintain good recognition accuracy (i.e., low false acceptance or high rejection rate) even when the quality of the input speech (e.g., utterance) is degraded, or when the acoustical, articulatory, or phonetic characteristics of speech in the training and testing environments differ. Even systems that are designed to be speaker independent may exhibit dramatic degradations in recognition accuracy when training and testing conditions differ. Despite significant advances in providing noise robustness, inherent mismatch between training and test conditions still pose a major problem. Most noise robustness approaches for speech processing can be generally divided into three broad techniques including using robust features (i.e., discriminative measurement similarity), speech enhancement, and model compensation. For example, the model compensation involves usage of recognition models for speech and noise as well. In particular, to adapt to the noisy environment the recognition models are appropriately compensated.

A popular noise robustness approach based on model compensation uses knowledge of an noisy environment extracted from training speech data in Parallel Model Combination (PMC) to transform the means and variances of speech models that had been developed for clean speech to enable these models to characterize noisy speech. A conventional PMC-based technique that may be used to improve the noise robustness of a variety of speech or speaker recognition systems provides an analytical model of the degradation that accounts for both additive and convolutional noise. Specifically, the speech to be recognized is modeled by speech models, which have been trained using clean speech data. Similarly, the background noise can also be modeled using a noise model. Accordingly, speech that is interfered by additive noises can be composed of a clean speech model and a noise model to form the parallel model combination. Although this conventional PMC-based technique works reasonably well under controlled or known environments, however, when deployed in noisy environments it may be computationally expensive and may rely on accurate estimates of the background noise. Thus, the conventional PMC may be inadequate for reliable speech processing under adverse conditions, such as in noisy environments.

Another technique that can be used under adverse or degraded conditions (e.g., noisy environments) to compensate for mismatches between training and testing conditions incorporates computing empirical thresholds for empirical comparisons of features derived from high quality (i.e., clean) speech with features of speech that are simultaneously recorded. Unfortunately, empirical thresholds based approaches have the disadvantage of requiring dual databases of speech (e.g., utterances) that are simultaneously recorded in the training and testing environments. Thus empirical methods may be unable to provide acceptable results when the testing environment changes. Therefore, regardless of a PMC-based noise robustness or non-PMC noise robustness, a noise compensation technique is desired for more reliable speech processing in speech or speaker recognition systems while operating under adverse conditions.

Thus, there is need to decrease noise sensitivity while processing speech for reliable speech or speaker recognition under adverse conditions.

### BRIEF DESCRIPTION OF THE DRAWINGS

FIG. 1A is a block diagram of a processor-based device including a noise compensation application, in accordance with one embodiment of the present invention;

FIG. 1B is a block diagram of a mobile device including details for the noise compensation application of FIG. 1A that may be employed in a communications system, in accordance with one embodiment of the present invention;

FIG. 2 is a schematic depiction of speech processing under noisy conditions that may be employed in the communications system of FIG. 1B according to one embodiment of the present invention;

FIG. 3 is a flow chart of speech or speaker recognition under noisy conditions in accordance with one embodiment of the present invention;

FIG. 4 is a schematic depiction of a noise compensation application of FIG. 1A for speech or speaker recognition under noisy conditions consistent with one embodiment of the present invention;

FIG. 5A is a partial flow chart of the noise compensation application based on FIG. 4 for speech or speaker recognition under noisy conditions in accordance with one embodiment of the present invention; and

FIG. 5B is a partial flow chart of the noise compensation application of FIG. 5A for speech or speaker recognition under noisy conditions in accordance with one embodiment of the present invention.

### DETAILED DESCRIPTION

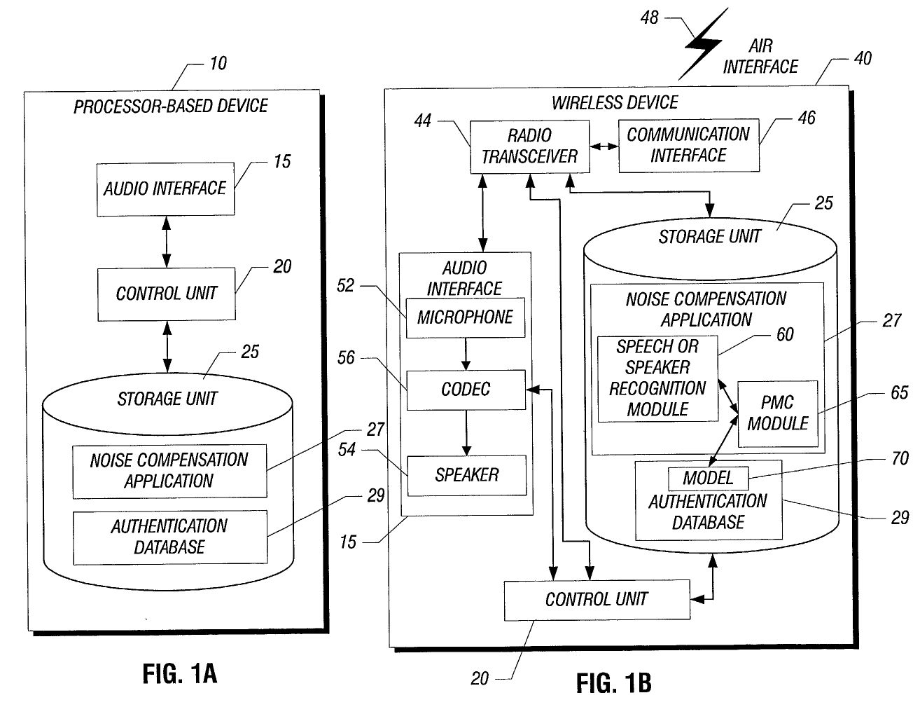

A processor-based device 10, as shown in FIG. 1A, in one embodiment, includes an audio interface 15 that generates or receives an audio signal (e.g., a noisy speech signal) comprising at least two signal portions including speech. In one embodiment, a control unit 20 may be operably coupled to the audio interface 15 to determine signal attributes and noise attributes of the two signal portions of the noisy speech signal. In one embodiment, the processor-based device 10 comprises a storage unit 25 coupled to the control unit 20. To derive a distance measure for one signal portion by using the signal attributes of two signal portions of the noisy speech signal, in one embodiment, the storage unit 25 may store a noise compensation application 27 and an authentication database 29.

As described in more detail below, in operation, the noise compensation application 27, when executed in conjunction with the authentication database 29, may, in one embodiment, enable the processor-based device 10 to derive the distance measure as a relative noise measure between the two signal portions of the noisy speech signal by distributing the signal attributes across both the signal portions. In one embodiment, to derive the relative noise measure, the noise compensation application 27 receives training speech data including noise components stored in authentication database 29 and the two signal portions of the noisy speech signal from the audio interface 15. The relative noise measure is obtained in order to calculate a mismatch indicative of a noise differential between the noise components present in the training speech data and the noise attributes present in the two signal portions of the noisy speech signal.

For assessing the speech included in the noisy speech signal based on the relative noise measure, the signal attributes of the two signal portions of the noisy speech signal may be combined into a first collection indicative of signal content. Likewise, the signal and noise attributes of the two signal portions of the noisy speech signal may be combined into a second collection indicative of a signal and noise content. Using both the collections, a compensation ratio of the signal and noise content to the signal content may be calculated. This compensation ratio may be used to determine the mismatch indicative of the noise differential.

Typically speech or speaker recognition involves identifying a specific speaker out of a known population of speakers, or verifying the claimed identity of a user, thus enabling controlled access to a location (e.g., a secured building), an application (e.g., a computer program), or a service (e.g., a voice-activated credit card authorization or a telephone service). In some cases, one is interested not in the underlying linguistic content, but the identity of the speaker, or the language being spoken. As an example, a variety of speech/speaker recognition products, especially portable devices (e.g., mobile phones), under noisy conditions, require a significantly improved accuracy in speech recognition and/or speaker verification. Examples of speaker verification include text-dependent speaker verification that may be used for authentication. Another application may be for authentication or fraud detection in test-independent speaker recognition. Examples of speech recognition include a variety of forms of speech recognition including isolated, connected, and/or continuous that may be performed in recognition software employed in a speech/speaker recognition product.

As an example, speaker recognition including verification or identification can be an important feature in portable devices, including processor-based devices such as mobile phones, or personal digital assistants (PDAs) especially for securing private information. Thus, the false acceptance of imposters may be kept very low (e.g., below 0.1%) in some embodiments.

In general, most techniques in speaker recognition including verification or identification are based on computing a distance measure between a test utterance and one or more models. Typically, the computed distance measure is usually either probabilistic (likelihood) or weighted Euclidean. When training speech data is clean and testing data is noisy (additive noise), any mismatch causes the distance measure to be inaccurate.

A common technique, which is used to overcome this mismatch, is called PMC (Parallel Model Combination). In a typical PMC technique, during testing the statistical attributes of the noise are estimated on-line, i.e., on a frame-by-frame basis. The estimated statistical attributes of noise are combined into a trained model, thus simulating a model trained on noisy speech with the same noise attributes as that of the test utterance.

However, the combination of the noise with the trained model is done in frequency space. By assuming independence of noise and signal power-spectra, the estimated power-spectrum of the noise is added to the power-spectra of each component of the trained model. Thereafter, the outcome is transformed to feature space (e.g., using Mel-scale Filter bank based Cepstrum Coefficients—MFCC). When using PMC with various signal-to-noise ratios and different kinds of noises (e.g., additive noise or convolutional noise), the characteristic distance level is changed because the distance is computed in Cepstrum space, not in frequency space, therefore the distance is not invariant to addition of the same term to both train and test power-spectra.

Although the PMC method has been proven to be effective against additive noises, it does require that the background noise signals be collected in advance to train the noise model. This noise model is then combined with the original recognition model, trained by the clean speech, to become the model that can recognize the environment background noise. As is evident in actual applications, noise changes with time so that the conventional PMC method may not be ideal when processing speech in an adverse environment. This is true since there can be a significant difference between the background noise previously collected and the background noise in the actual environment.

In particular, obstacles to noise robustness in speaker recognition system include degradations produced by noise (e.g., additive noise), the effects of linear filtering, non-linearities in transmission, as well as impulsive interfering sources, and diminished accuracy caused by changes in articulation produced by the presence of noise sources. Consequently, for training purposes, relatively large speech samples may be collected in a host of different environments. An alternative approach is to generate training speech data synthetically by filtering clean speech with impulse responses and adding noise signals from the target domain. However, still in real applications, additive or convolutive noise creates a mismatch between training and recognition environments, thereby significantly degrading performance.

Moreover, speech or speaker recognition systems are designed for use with a particular set of words, but system users may not know exactly which words are in the system vocabulary. This leads to a certain percentage of out-of-vocabulary words in natural conditions. Speech or speaker recognition systems may have some method of detecting such out-of-vocabulary words, or they will end up mapping a word from the vocabulary onto the unknown word, causing an error. Speaker-to-speaker differences impose a different type of variability, producing variations in speech rate, co-articulation, context, and dialect. Most such systems assume a sequence of input frames, which are treated as if they were independent.

Unfortunately, such PMC-based approaches though quite useful for closed-set identification (e.g., in laboratory or known environments) may be less ideal when dealing with open-set identification, such as speaker verification for authentication or specific speech recognition tasks in noisy conditions. For a closed-set identification problem there is no need for an absolute-normalized score. However, there is a need for a normalized absolute score in an open-set identification problem. Thus, under adverse conditions an increased level of noise robustness may be desired while undertaking speaker verification and speech identification for more accurate recognition.

A wireless device 40 of FIG. 1B, in one embodiment, is similar to that of FIG. 1A (and therefore, similar elements carry similar reference numerals) with the addition of more details for the audio interface 15, the noise compensation application 27 and the authentication database 29. The audio interface 15 includes a microphone 52, a speaker 54 and a coder/decoder (codec) 56 coupled to both the microphone 52 and speaker 54. In one embodiment, the noise compensation application 27 comprises a speech or speaker recognition module 50 and a parallel model compensation module 65. In addition, the wireless device 40 further comprises a radio transceiver 44 coupled to a communication interface 46. Finally, the authentication database 29 includes a model 70 to provide a framework for recognizing the speech or a speaker of one or more speakers, which, may, or may not be pre-registered.

When operational, the wireless device 40, in one embodiment, may receive one or more radio communications over an air interface 48, where the radio communications may be used to communicate with a remotely located transceiver, such as a base station. In one embodiment, the authentication database 29 may store the training speech data including one or more training templates. Additionally, one or more models for recognizing the speech from the noisy speech signal may also be stored in the authentication database 29. To determine the mismatch between the noise components and the noise attributes, in one embodiment, based on the model 70 trained on the training speech data, a signal profile may be derived from a training template.

In one embodiment, the speech or speaker recognition module 60 extracts from a noisy speech signal an utterance received over the air interface 48 via communication interface 46 and radio transceiver 44. The utterance may include one or more first portions with first signal-and-noise attributes and one or more second portions with second signal-and-noise attributes. The utterance may be extracted based on the model 70 resident in the authentication database 29 where the recognition model 70 may have been trained on the training speech data. By selectively combining across the noisy speech signal the first and second signal-and-noise attributes of both the first and second portions, a compensation term for compensating the model 70 may be derived by accounting for the mismatch between the noise components and noise attributes.

Using the PMC module 65, the model 70 may be compensated based on the compensation term. The compensation term may reduce the mismatch, i.e., it more accurately accounts for the noise differential between the utterance, and the model 70 that originally may have been trained on the training speech data. In this case, the PMC module 65 may determine for the model 70, the compensation term as a function of the mismatch. In one embodiment, the model 70 comprises a plurality of recognition models including at least one speech model and at least one noise model. The speech and the noise models may be trained from the training speech data stored in the authentication database 29 before the execution of the noise compensation application 27.

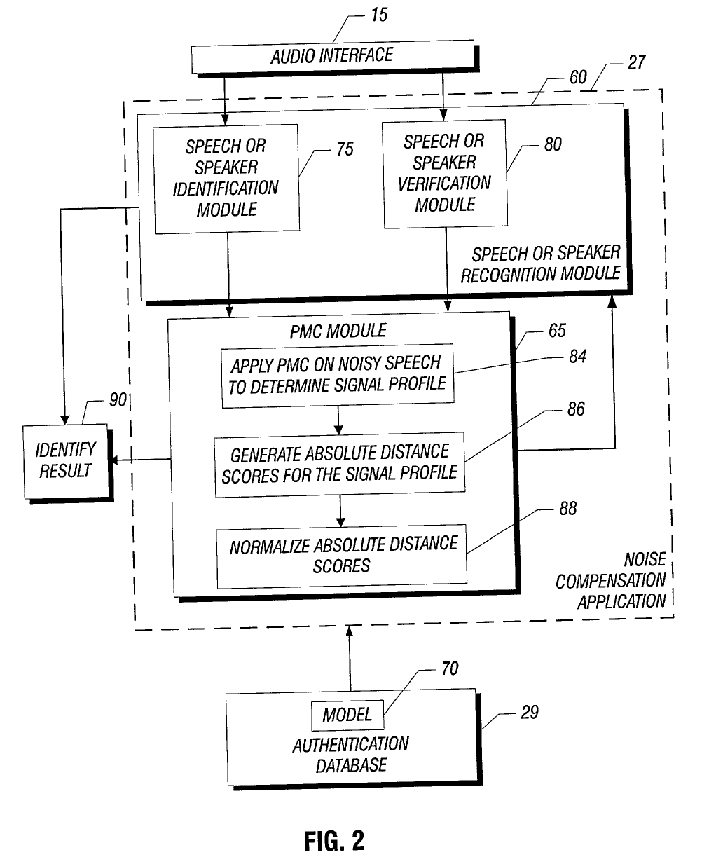

In operation, the audio interface 15, shown in FIG. 2, directs a noisy speech signal to the speech or speaker recognition module 60 of the noise compensation application 27. The speech or speaker recognition module 60 comprises a speech or speaker identification module 75 and a speech or speaker verification module 80 for performing speech processing in one embodiment. Depending upon whether the aim is to perform identification or verification for the speech or speaker of the utterance, the noisy speech signal may be selectively provided either to the speech or speaker identification module 75, or to the speech or speaker verification module 80. Alternatively, if both the identification and the verification for the speech or the speaker are desired, the noisy speech signal may be provided to both the speech or speaker identification module 75 and speech or speaker verification module 80.

In one embodiment, for speech processing, the PMC module 65 applies parallel model compensation on the noisy speech signal at block 84. A signal profile in terms of its signal and noise content may be determined to derive the mismatch that occurs between the model 70 and the utterance of the noisy speech signal. In one embodiment, absolute distance scores for the first and second signal-and-noise attributes of both the first and the second portions of the utterance may be generated. The absolute distance scores may be normalized at the block 88 to provide normalized absolute distance scores for the first and second signal-and-noise attributes of both the first and second portions of the utterance. Then the compensation term may be calculated from the normalized absolute distance scores for compensating the model 70 according to the mismatch evident from the signal profile.

When the noise compensation application 27 is executed by the control unit 20 (FIGS. 1A and 1B), the speech or speaker identification module 75 or the speech or speaker verification module 80, the speech or the speaker recognition module 60 may be used in order to identify a result related to either identification, verification, or both based on the authentication database 29 as indicated at the block 90 in FIG. 2. More specifically, in one embodiment, the speech or speaker identification module 75 compares the normalized absolute distance scores with a threshold associated with a speech profile to verify a speaker of the utterance against the speech profile. Likewise, the speech or speaker verification module 80 compares the normalized absolute distance scores against the authentication database 29 to identify the speaker of the utterance against a plurality of speech profiles associated with one or more registered speakers.

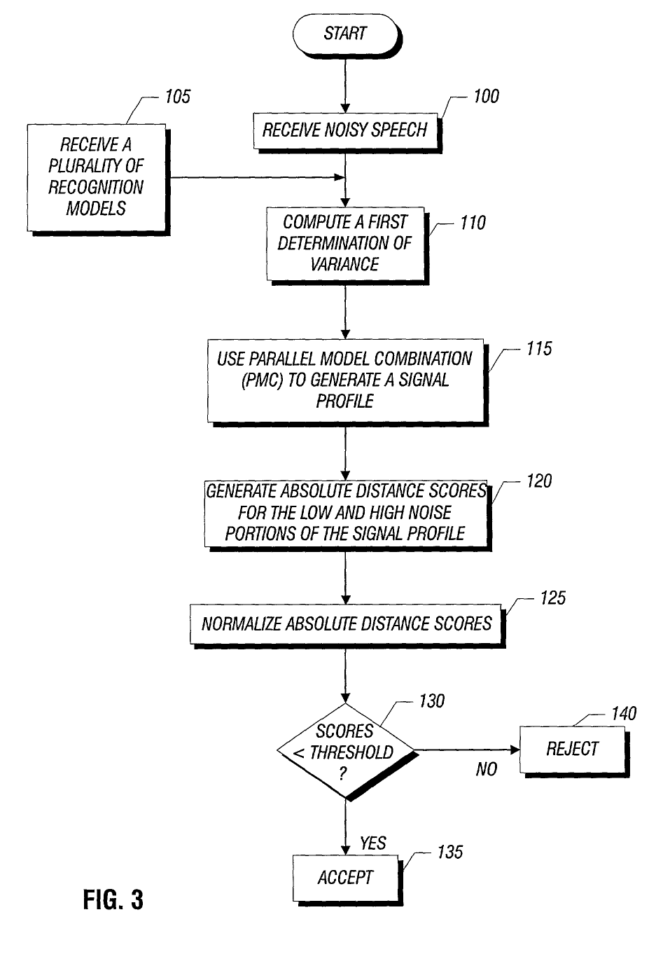

FIG. 3 shows programmed instructions performed by the noise compensation application 27 (FIGS. 1A) resident at the storage unit 25 according to one embodiment of the present invention. As shown in FIG. 3, at block 100, noisy speech including a test utterance may be received, for example, either from a registered speaker or an unknown speaker. At block 105, a plurality of recognition models including speech and noise models and training speech data for noisy environments may be received.

Using the test utterance and one or more models (e.g., speech, and noise models trained on training speech data) a first determination of the variance of noise levels between the test utterance and the models may be computed at block 110. In block 115, parallel model compensation (PMC) may be used to generate a signal profile having low and high noise portions indicating the mismatch between the test utterance and training speech data. Absolute distance scores for the low and high noise portions of the signal profile may be generated at block 120. Then the absolute distance scores may be normalized to compute a second determination of variance of noise levels.

A check at diamond 130 indicates whether the normalized absolute distance scores are less than a threshold. If the check is affirmative, the test utterance may be accepted as being associated with the speaker at block 135. Conversely, if the check fails, the test utterance may be rejected at block 140 because the second determination of variance of noise levels may be insufficient to verify the speech or speaker of the test utterance.

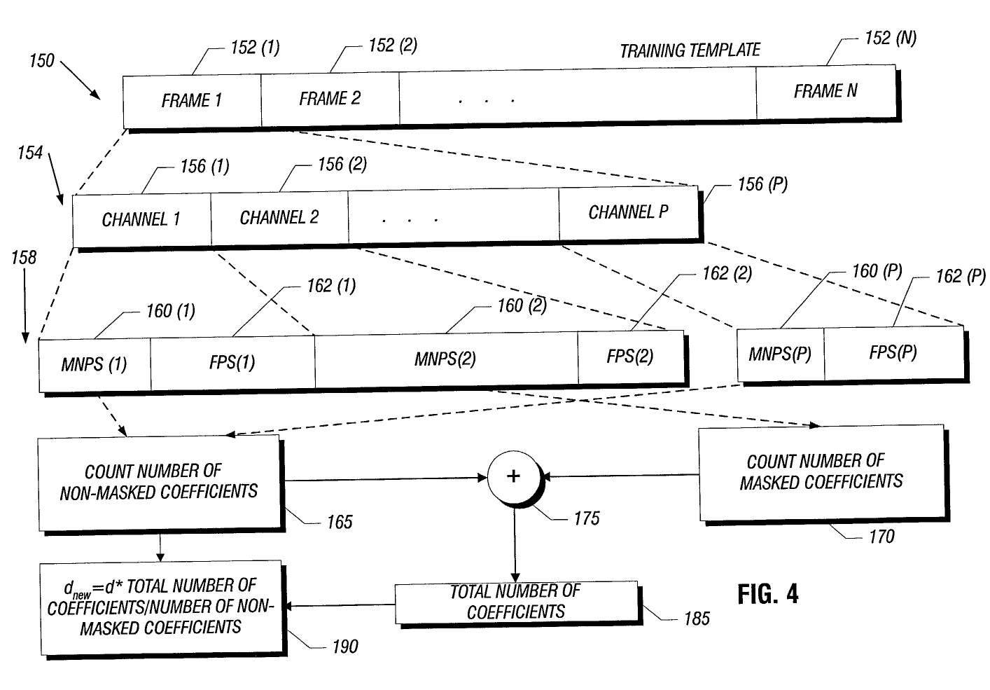

In one embodiment, a training template 150, for a general architecture shown in FIG. 4, may enable noise robustness in mobile devices. The training template 150 includes a plurality of frames 152(1) through 152(N). At level 154, for each frame 152 of the plurality of frames 152(1) through 152(N), a plurality of channels 156(1) through 156(P) may be derived. At level 158, for each channel 156 of each frame of the training template 150, mean noise power spectrum (MNPS) 160(1) through 160(P) and frame power spectrum (FPS) 162(1) through 162(P) may be determined to compute coefficients of log-filter bank. The low power coefficients may be selectively masked according to one embodiment of the present invention to calculate the second determination of variance of noise levels consistent with the general architecture of FIG. 4.

Essentially, the general architecture of FIG. 4 entails separately counting the non-masked coefficients 165 and the number of masked coefficients 170 where masking encompasses identification of missing or assessment of the unreliable parts of the training template 150. These non-masked and masked coefficients 165, 170 may be selectively combined using a summer 175 to determine the total number of coefficients 185. Finally, using a ratio of the total number of coefficients 185 to the number of masked coefficients 170, the second determination of variance of noise levels (dnew) may be made based on the first determination of variance of noise levels (d) at block 190.

According to one embodiment of the present invention, speech recognition or speaker identification may be performed in two phases namely, a training phase and a testing phase. In the training phase, an audio signal from a speaker uttering a specific word may be recorded. For example, a password (e.g., name of the speaker) may be recorded one or more times during an enrollment process. The password later may be treated as a secret signature of the speaker to identify the speaker. A computer system having a processor and a memory may receive the audio signal to convert the secret signature into one or more spectrum features associated with the password. The spectrum features may be readily stored in the memory of the computer system.

In the testing phase, for example, to access a secured system (e.g., for executing a transaction), the password from the speaker may be presented to the computer system as the test utterance. A comparison may be performed between the stored secret signature and the test utterance. However, in a noisy environment, such as including a background noise at least in part caused by a moving car may present more noise than what may have been present in the training phase, as the training phase may have been carried out in relatively quieter environment. This causes a mismatch between the secret signature and the test utterance when the computer system matches the secret signature to the test utterance for the speech recognition or speaker identification. A distance measure may be calculated to determine the mismatch. The background noise, however, causes the distance measure to become larger even if the speaker of both the secret signature and the test utterance is the same.

To counter this, a PMC algorithm records the noise during the testing phase and artificially adds the noise to the training speech data. This simulates a scenario for the testing phase that resembles the noisy conditions with the training phase, thereby substantially reducing the mismatch between the training and testing phases. To the extent the mismatch is compensated, the distance measure may be used to identify the speaker. That is, if the distance measure turns out to be less than a threshold, the speaker of both the secret signature and the test utterance as well may be identified to be the same. Instead, if the distance measure turns out to be more than the threshold then the speaker is identified as an imposter.

Although the PMC algorithm performs reasonably well in the case of speaker independent speech recognition, the case of speaker dependent speech recognition poses some problems. One problem relates to artificial addition of noise to the training speech data while compensating for the mismatch. In particular, the distance measure may be over compensated, i.e., reduced too much. Thus, a final score obtained in this manner may be highly dependent on the noise level. Therefore, if the environment is extremely noisy, a substantial amount of the noise may be added to the training speech data. As a result, a comparison between the secret signature and the test utterance may turn out to be a relative noise measure that indicates a significantly small difference between the noise levels present in the secret signature and the test utterance. Accordingly, almost a negligible distance measure may be attributed to the significantly small difference between the noise levels present in the secret signature and the test utterance.

The PMC algorithm provides for a check that either accepts a speaker where the final score is greater than the threshold or rejects the speaker where the final score is smaller than the threshold. However, the PMC algorithm alone may not perform satisfactorily in the speaker dependent case, as the final score may simply not be correctly compared to a threshold that is static in nature. Instead, in noisy environments, the threshold is a function of a noise level of the noisy speech signal and the training speech data. The noise level may thus be derived from specific noise characteristic estimated from a noise spectrum of a portion of the noisy speech signal before the test utterance.

In one embodiment, a dynamic threshold is calculated. The dynamic threshold is derived using the PMC algorithm. More specifically, the PMC algorithm is applied to derive a spectrum of a time interval in the training speech data and noise is artificially added. Then, a check is performed to ascertain whether the training speech data is changed beyond a certain level. If so, a counter is incremented to determine how much the application of the PMC algorithm changed the training speech data. Accordingly, to the extent the training speech data may have been changed in response to the application of the PMC algorithm, the dynamic threshold may be proportionately changed as well.

For the training template 150 that as example may comprise hundreds of frames, may be processed on a frame-by-frame basis to derive a signal spectrum at the level 154. By implementing the PMC algorithm to selectively mask portions of the signal spectrum, the dynamic threshold may be obtained. For example, if at a specific frequency it is determined that a higher level of noise is present than the signal, an assertion is made to the fact that the noise is more significant at this particular frequency than the test utterance. To this end, a portion of the test utterance associated with the specific frequency may be masked. In particular, the portion of the test utterance associated with the specific frequency may be replaced with the noise. In one embodiment, the number of times the masking is carried out may be counted to update the dynamic threshold every time the masking is done.

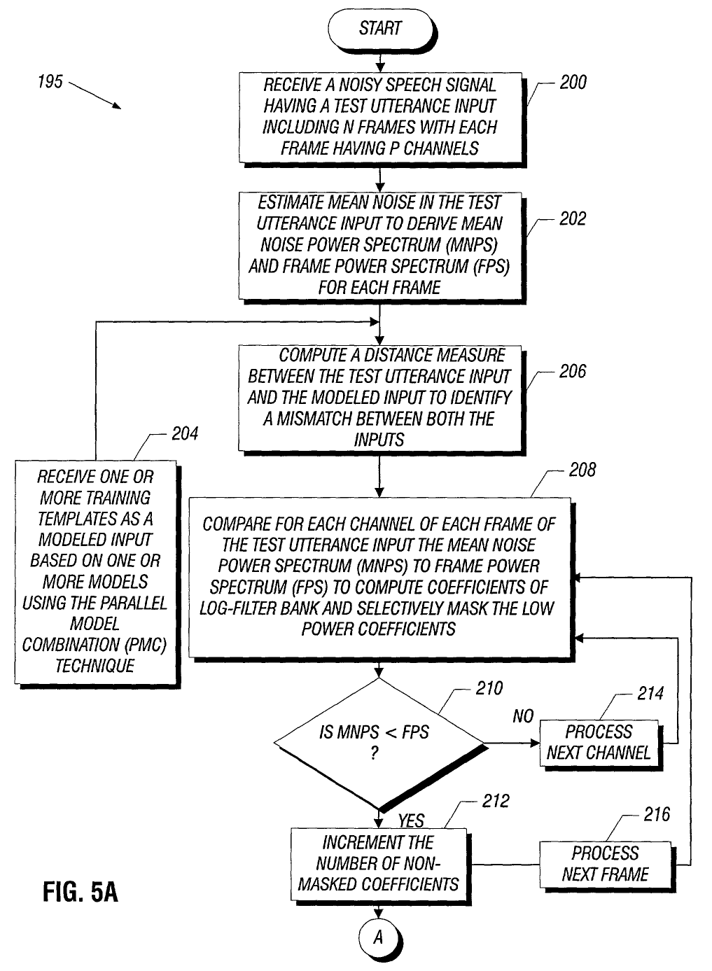

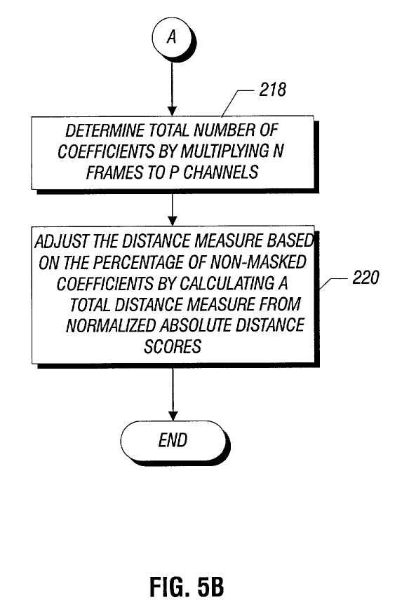

As shown in FIGS. 5A and 5B, in accordance with one embodiment of the present invention, the general architecture illustrated in FIG. 4 may be implemented in the noise compensation application 27 (FIG. 1A) by speech or speaker recognition software 195. In such case, each of the actions indicated by blocks 154 through 190 (FIG. 4) may be implemented in software after receiving the results of the operations, which, may be implemented in hardware in one embodiment. Additionally, the speech or speaker recognition software 195 may be stored, in one embodiment, in the storage unit 25 (FIG. 1B) of a processor-based device, such as the wireless device 40 shown in FIG. 1B.

Referring to FIG. 5A, at block 200, a noisy speech signal having a test utterance input including “N” frames with each frame having “P” channels may be received. Using the general architecture of FIG. 4, the speech or speaker recognition software 195 may estimate mean noise in the test utterance input to derive a mean noise power spectrum (e.g., MNPS(1) 160(1) through MNPS(P) 160(P) of FIG. 4)) and frame power spectrum (e.g., FPS(1) 162(1) through FPS(P) 162(P)) for each frame as indicated in block 202.

At block 204, one or more training templates as a modeled input may be received. The modeled input may be based on one or more models. Using a parallel model combination (PMC) technique (e.g., PMC module 65 of FIG. 2) a distance measure between the test utterance input and the modeled input may be computed to identify a mismatch between both the inputs at block 206. In one case, using the actions indicated at the blocks 154 to 158 (FIG. 4) to compute coefficients of log-filter bank and selectively mask the low power coefficients, for each channel of each frame of the test utterance input, the estimates of the MNPS and FPS are compared at block 208.

A check for each channel may be performed at diamond 210 as to whether the mean noise power spectrum (MNPS) is less than the frame power spectrum (FPS). When the check is affirmative, i.e., MNPS is indeed less than FPS for a particular channel being processed, the number of associated non-masked coefficients may be incremented and duly counted at block 212. Then the next channel is processed at block 214 in an iterative manner. All of the “P” channels of each frame are processed iteratively at block 216 until all the “N” frames in the test utterance input are finished. Once all the “N” frames are finished, the total number of coefficients may be determined by multiplying “N” frames by “P” channels at block 218 in FIG. 5B. Finally, at block 220, the distance measure may be adjusted based on the percentage of non-masked coefficients by calculating a total distance measure from the normalized absolute distance scores as detailed in FIG. 2.

While applying the parallel model compensation (PMC) technique to evaluate the speech of the noisy speech signal, in one embodiment, the model 70 (FIG. 1B) may be readily compensated in response to the relative noise measure in some embodiments. Thus, noise sensitivity may be reduced, as noise robustness is improved to provide better recognition accuracy (i.e., lower false acceptable or higher rejection rate). In this way, the noise compensation application 27 (FIG. 1B) may enable more reliable speech processing in speech or speaker recognition systems that may be operating under adverse conditions (e.g., in noisy environments).

In one embodiment, Cepstrum coefficients may be computed by applying a Discrete Cosine Transform (DCT) to a set of log-filter bank coefficients. Essentially, the DCT is (almost) an orthonormal transform, which means that it is (almost) invariant to Euclidean distance. Based upon this, a technique may be readily incorporated in PMC that computes Euclidean distance between two Cepstra vectors as (almost) equivalent to Euclidean distance between two log-filter bank vectors. Such a PMC-based approach indicates that when neglecting the variance of the noise and assuming the noise mean is estimated accurately, for each single frame, the coefficients of the log-filter bank which contain lower power than noise are masked, i.e., neglected or dropped. As a result, masked coefficients end up contributing a close to zero distance to a total distance indicative of cumulative noise measure. This phenomenon leads to decreasing of the total distance as Signal-to-Noise Ratio (SNR) decreases. Counting the number of coefficients over all frames in which this masking doesn't occur may compensate such decrease. Accordingly, in one embodiment, the percentage of coefficients in which masking doesn't occur may be used to normalize the total distance for Dynamic Time Warping (DTW)-template based speaker verification and/or speaker dependent speech recognition.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining signal attributes and noise attributes of at least two signal portions including speech; and
deriving a distance measure for one signal portion by using the signal attributes of both signal portions.

2. The method of claim 1, wherein deriving the distance measure including deriving a relative noise measure between the at least two signal portions by distributing the signal attributes over the at least two signal portions.

3. The method of claim 2, including:
receiving training speech data including noise components and the at least two signal portions;
combining the signal attributes of the at least two signal portions into a signal content and combining the signal and noise attributes of the at least two signal portions into a signal and noise content;
calculating a compensation ratio of the signal and noise content to the signal content in order to derive the relative noise measure; and
adjusting a mismatch indicative of a noise differential between the noise components present in the training speech data and the noise attributes present in the at least two signal portions based on the relative noise measure.

4. The method of claim 3, including deriving from a training template, a signal profile based on a model trained on the training speech data to determine the mismatch between the noise components and the noise attributes.

5. The method of claim 4, including compensating the model in response to the relative noise measure while applying a parallel model combination mechanism.

6. A method comprising:
extracting from a noisy speech signal an utterance, said noisy speech signal including a first portion with first signal-and-noise attributes and a second portion with second signal-and-noise attributes, wherein said utterance extracted from the noisy speech signal based on a first model trained on training speech data;
selectively combining across the noisy speech signal the first and second signal-and-noise attributes of both the first and second portions to derive a compensation term for the first model;
deriving a second model by compensating the first model based on the compensation term; and
correcting a mismatch indicative of a noise differential between the first portion and the second portion based on the second model.

7. The method of claim 6, including using a parallel model combination mechanism to determine said mismatch as a function of the compensation term, said first model based on a plurality of recognition models including at least one speech model and at least one noise model.

8. The method of claim 7, including training the at least one speech model and the at least one noise model with the training speech data.

9. The method of claim 6, wherein combining includes generating absolute scores for the first and second signal-and-noise attributes of both the first and second portions of the noisy speech signal.

10. The method of claim 7, wherein combining further includes:
normalizing the absolute scores to generate normalized absolute scores for the first and second signal-and-noise attributes of both the first and second portions of the noisy speech signal; and
calculating the compensation term from the normalized absolute scores.

11. An article comprising a medium storing instructions that enable a processor-based system to:
determine signal attributes and noise attributes of at least two signal portions including speech; and
derive a distance measure for one signal portion by using the signal attributes of both signal portions.

12. The article of claim 11, further storing instructions that enable the processor-based system to:
derive the distance measure by determining a relative noise measure between the at least two signal portions to distribute the signal attributes over the at least two signal portions.

13. The article of claim 12, further storing instructions that enable the processor-based system to:
receive training speech data including noise components and the at least two signal portions;
combine the signal attributes of the at least two signal portions into a signal content and combine the signal and noise attributes of the at least two signal portions into a signal and noise content;
calculate a compensation ratio of the signal and noise content to the signal content in order to derive the relative noise measure; and
adjust a mismatch indicative of a noise differential between the noise components present in the training speech data and the noise attributes present in the at least two signal portions based on the relative noise measure.

14. The article of claim 13, further storing instructions that enable the processor-based system to derive from a training template, a signal profile based on a model trained on the training speech data to determine the mismatch between the noise components and the noise attributes.

15. The article of claim 14, further storing instructions that enable the processor-based system to compensate the model in response to the relative noise measure while applying a parallel model combination mechanism.

16. An article comprising a medium storing instructions that enable a processor-based system to:
extract from a noisy speech signal an utterance, said noisy speech signal including a first portion with first signal-and-noise attributes and a second portion with second signal-and-noise attributes, wherein said utterance extracted from the noisy speech signal based on a first model trained on training speech data;
selectively combine across the noisy speech signal the first and second signal-and-noise attributes of both the first and second portions to derive a compensation term for the first model;
derive a second model by compensating the first model based on the compensation term; and
correct a mismatch indicative of a noise differential between the first portion and the second portion based on the second model.

17. The article of claim 16, further storing instructions that enable the processor-based system to use a parallel model combination mechanism to determine said mismatch as a function of the compensation term, said first model based on a plurality of recognition models including at least one speech model and at least one noise model.

18. The article of claim 17, further storing instructions that enable the processor-based system to train the at least one speech model and the at least one noise model with the training speech data.

19. The article of claim 16, further storing instructions that enable the processor-based system to generate absolute scores for the first and second signal-and-noise attributes of both the first and second portions of the noisy speech signal.

20. The article of claim 17, further storing instructions that enable the processor-based system to combine further includes:
normalize the absolute scores to generate normalized absolute scores for the first and second signal-and-noise attributes of both the first and second portions of the noisy speech signal; and
calculate the compensation term from the normalized absolute scores.

21. The article of claim 20, further storing instructions that enable the processor-based system to:
compare the normalized absolute scores with a threshold associated with a speech profile to verify a speaker of the utterance against the speech profile; and
compare the normalized absolute scores with a database including a plurality of speech profiles associated with one or more registered speakers to identify the speaker of the utterance against the database.

22. The article of claim 20, further storing instructions that enable the processor-based system to calculate includes:
use a training template including a plurality of frames each frame including one or more channels each channel including first segments with lower signal-to-noise portions and second segments with higher signal-to-noise portions; and
compensate the model for the mismatch in the utterance and the training template based on the compensation term by counting over all the frames of the plurality of frames both the first segments with lower signal-to-noise portions and the second segments with higher signal-to-noise portions in the utterance of the noisy speech signal.

23. The article of claim 22, further storing instructions that enable the processor-based system to derive the compensation term from the mismatch by using a ratio of the total number of the first and second segments to the second segments.

24. The article of claim 23, further storing instructions that enable the processor-based system to:
extract from the first segments non-masked coefficients for each channel of the one or more channels of each frame of the plurality of frames of the training template; and
extract from the second segments masked coefficients for each channel of the one or more channels of each frame of the plurality of frames of the training template.

25. The article of claim 24, further storing instructions that enable the processor-based system to extract from the first segments by counting the number of non-masked coefficients over all the frames of the plurality of the frames, and to extract from the second segments by counting the number of masked coefficients for each frame of the plurality of the frames on a frame-by-frame basis.

26. The article of claim 24, further storing instructions that enable the processor-based system to extract from the first and second segments by counting the number of corresponding masked and non-masked coefficients associated with a log-filter bank.

27. An apparatus comprising:
an audio interface to receive at least two signal portions including speech; and
a control unit operably coupled to the audio interface, the control unit to determine signal attributes and noise attributes of the at least two signal portions including speech and to derive a distance measure for one signal portion by using the signal attributes of both signal portions.

28. The apparatus of claim 27, further comprising:
a storage unit including an authentication database, said storage unit coupled to the control unit to store training speech data in the authentication database, wherein the control unit to:
derive the distance measure from a relative noise measure between the at least two signal portions by distributing the signal attributes over the at least two signal portions.
receive training speech data including noise components and the at least two signal portions to calculate a mismatch indicative of a noise differential between the noise components present in the training speech data and the noise attributes present in the at least two signal portions;
combine the signal attributes of the at least two signal portions into a signal content and combining the signal and noise attributes of the at least two signal portions into a signal and noise content to calculate a compensation ratio of the signal and noise content to the signal content; and
adjust the mismatch with the compensation ratio in order to assess the speech based on the relative noise measure.

29. A wireless device comprising:
an audio interface to receive a noisy speech signal including an utterance;
a control unit operably coupled to the audio interface; and
a storage unit operably coupled to the control unit, said control unit enables:
determining signal attributes and noise attributes of at least two signal portions including speech, and
deriving a distance measure for one signal portion by using the signal attributes of both signal portions.

30. The wireless device of claim 29 comprises a radio transceiver and a communication interface both adapted to communicate over an air interface.
